(19) United States
(12) Patent Application Publication
(10) Pub. No.: US 2017/0309999 A1
(43) Pub. Date: Oct. 26, 2017

(54) MULTI-RADIO DEVICE WITH ENCLOSED ANTENNAS TO PREVENT NEAR FIELD INTERFERENCE FROM NEARBY OBJECTS

(71) Applicants: Ken Margon, Oakland, CA (US); Pragash Sangaran, Oakland, CA (US)

(72) Inventors: Ken Margon, Oakland, CA (US); Pragash Sangaran, Oakland, CA (US)

(21) Appl. No.: 15/498,370

(22) Filed: Apr. 26, 2017

Related U.S. Application Data
(60) Provisional application No. 62/327,797, filed on Apr. 26, 2016.

(51) Int. Cl. H01Q 1/52; H01Q 1/36; H01Q 1/24; H01Q 1/38; H01Q 5/30

(52) U.S. Cl. CPC H01Q 1/523; H01Q 1/38; H01Q 5/30; H01Q 1/241; H01Q 1/36

(57) ABSTRACT

The present invention provides a multi-radio device with enclosed antennas. In an embodiment of the invention, a multi-radio device comprises a printed circuit board (PCB) placed vertically in an enclosure and the antennas are connected through connectors at the top of the PCB without cables or are printed on the main PCB. The antenna PCBs and main PCB are held in position by an RF neutral, e.g., plastic, enclosure so that the RF characteristics are much more consistent from device to device.

### CROSS REFERENCE TO RELATED APPLICATION

This present invention claims priority to U.S. Provisional Patent Application No. 62/327,797, filed on Apr. 26, 2016, and entitled, “Multi-Radio Device with Enclosed Antennas to Prevent Near Field Interference from Nearby Objects,” the disclosure of which is incorporated by reference herein in its entirety.

### BACKGROUND OF THE INVENTION

### 1. Field of Invention

The present invention relates generally to health data informatics and analysis and more particularly to a system and method for the collection and analysis of data from consumed foods and health monitoring devices to manage patient physiological conditions.

### 2. Description of Related Art

With the proliferation of multi-radio devices that combine cellular communications with a wireless local area network (WLAN) operating at industry, scientific and medical (ISM) radio bands, solutions need to be developed that provide practical, low cost, and repeatable radio frequency (RF) performance. Coexistence of 4G cellular with WLAN can pose problems. For example, long-term evolution (LTE), which is a 4G cellular standard, communications interfere with IEEE 802.11/Wi-Fi or Bluetooth low energy (BLE) signals.

Standards bodies have published antenna isolation requirements and methods to prevent simultaneous transmissions of interfering signals. However, in order to meet these requirements, product designers typically have to make significant performance trade-offs in order meet the standards guidelines.

A major issue with these multi-radio devices is getting consistent performance characteristics under real world conditions. Devices, such as wireless routers, hubs, controllers and network appliances plug directly into a wall outlet or are placed near a wall. This results in near field effects created by the antennas' proximity to the wall, which reduces the efficiency of the antennas overall as well as increase the amount of energy absorbed by the wall. There are similar effects if the antennas are located near the floor or a ceiling. The antennas are affected adversely and consistency of performance becomes a major impediment to reliable performance.

The distance and the angle of each antenna in a multi-radio device are critical to providing enough isolation between antennas with coexisting technologies. This is particularly important between technologies such as LTE in the cellular bands and WiFi and/or BLE in the ISM bands because of the adjacent channel interference. This isolation cannot be done reliably for external antennas due to external disturbances such as walls and floors, and antenna rotation and orientation can be accidentally or unintentionally changed. Even if a device manufacturer states preferred antenna positions in a user manual, it is often ignored by user and when the performance of the device is not satisfactory, the manufacturer may be blamed.

### SUMMARY OF THE INVENTION

The present invention overcomes these and other deficiencies of the prior art by providing a multi-radio device that reduces the proximity of wireless antennas to a wall, ceiling, and/or floor, and positions antennas vertically in an enclosure to improve propagation, efficiency, and consistency. The positions of the antennas relative to other components are static, making the performance characteristics of the antennas stable. The physical relationship between each antenna is maintained to ensure that near field effects do not change the radiation pattern or detune an antenna passband.

In an embodiment of the invention, a multi-radio device comprises a printed circuit board (PCB) placed vertically in an enclosure and the PCB's printed antennas are connected through connectors at the top of the PCB without cables or are printed on the main PCB. The antenna PCBs and main PCB are held in position by an RF neutral, e.g., plastic, enclosure so that the RF characteristics are much more consistent from device to device.

In an embodiment of the invention, a device comprises: a first antenna associated with a first radio frequency (RF) technology; a second antenna associated with a second RF technology, wherein the first RF technology and second RF technology are different; and a pyramid shaped enclosure housing the first antenna and second antenna, and maintaining a spatial relationship between the first antenna and second antenna in order to minimize interference between the first antenna and second antenna. The first antenna or second antenna implements circular or elliptical polarization. The first RF technology is associated with a licensed band and the second RF technology is associated with an unlicensed band. The device may further comprise an electronic circuit board and the first antenna and second antenna are connected to the electronic circuit board through a connector, or a connector and cable. Alternatively, the device may further comprise an electronic circuit board, and the first antenna and second antenna are fabricated on the electronic circuit board.

In another embodiment of the invention, a device comprises: a first antenna associated with a first radio frequency (RF) technology; a second antenna associated with a second RF technology, wherein the first RF technology and second RF technology are different; and an RF neutral enclosure housing the first antenna and second antenna, and maintaining a spatial relationship between the first antenna and second antenna in order to minimize interference between the first antenna and second antenna. The first antenna or second antenna implements circular or elliptical polarization. The first RF technology is associated with a licensed band and the second RF technology is associated with an unlicensed band. The device may further comprise an electronic circuit board and the first antenna and second antenna are connected to the electronic circuit board through a connector, or a connector and cable. Alternatively, the device may further comprise an electronic circuit board, and the first antenna and second antenna are fabricated on the electronic circuit board.

In yet another embodiment of the invention, a device comprises: radio frequency (RF) circuitry; an RF antenna coupled to the RF circuitry; and an enclosure housing the RF antenna and RF antenna, and maintaining a spatial relationship between the RF circuitry and RF antenna in order to minimize interference between the RF circuitry and RF antenna. The RF circuitry and RF antenna implement one or more RF technologies. The enclosure is pyramid shaped. The enclosure is RF neutral. The RF antenna implements circular or elliptical polarization. The device further comprises an electronic circuit board, the electronic circuit board including the RF circuitry, and the RF antenna is connected to the electronic circuit board through a connector, or a connector and cable. Alternatively, the device further comprises an electronic circuit board, the electronic circuit board including the RF circuitry, and the RF antenna is fabricated on the electronic circuit board.

Multiple antennas for coexisting RF technologies such as LTE and BLE are placed in the enclosure more precisely (since the internal antenna is not affected by external objects/and is kept from moving relative to the other components of the device) than externally attached antennas based on the antenna isolation requirements which are affected by the wavelength (frequency) and antenna lobe pattern. The antennas used in this invention are dipole antennas to achieve high efficiency and are placed inside the device enclosure instead of external connectors.

The present invention improves radiation efficiency and gain of directional antennas. Compared to an external antenna, an internal antenna can be designed with adequate space from any external hindrance (ground, wall or other object) to minimize near and far field effects. Antenna position can be adjusted so directive gain/maximum gain is pointed towards the preferred direction of transmission with the preferred polarization. The antennas can be optimized with the near field effects of the enclosure and internal components since the antenna's position is static relative to the materials that affect the antenna. The present invention provides a unique solution for repeatable, consistent multi-radio device performance. This invention

The foregoing, and other features and advantages of the invention, will be apparent from the following, more particular description of the preferred embodiments of the invention, the accompanying drawings, and the claims

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 shows a multi-radio device according to an embodiment of the invention;

FIG. 2 illustrates a radiation pattern of a vertical antenna;

FIG. 3 illustrates a radiation pattern for a low dBi gain antenna such as those used for cellular in order to get the best omni-direction performance;

FIG. 4 illustrates a radiation pattern for a vertically polarized antenna;

FIG. 5A illustrates the back side of an enclosure for the device of FIG. 1 according to an embodiment of the invention;

FIG. 5B illustrates a rectangular enclosure according to an embodiment of the invention

FIG. 5C illustrates a pyramid shaped hub cover according to an embodiment of the invention; and

FIG. 6 illustrates directional behavior of an antenna according to an embodiment of the invention.

### DETAILED DESCRIPTION OF EMBODIMENTS

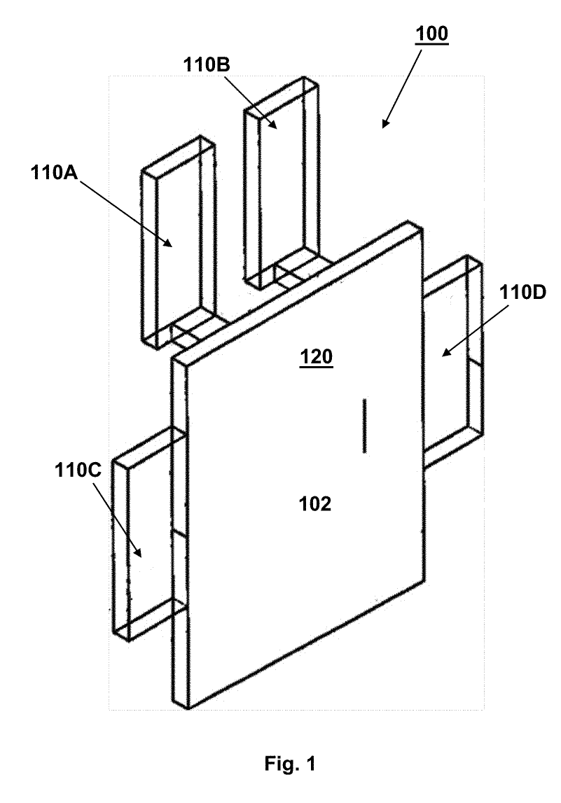

Preferred embodiments of the present invention and their advantages, as well as the operation of various embodiments of the invention are described in detail below with reference to the accompanying FIGS. 1-6.

FIG. 1 shows a multi-radio device 100 according to an embodiment of the invention. Four dipole antennas 110A-D are connected vertically to a main PCB 120 for vertical polarization. In an exemplary embodiment of the invention, antennas 110A and 110B are mounted at the top of PCB 120 and antennas 110C and 110D are mounted on opposite sides of the PCB 120. Although four antennas 110A-D are shown, the device 100 may include any number of antennas 110A-N. Four antennas 110A-D are shown to illustrate possible configurations. One or more printed antenna 130 may be included on the main PCB 120.

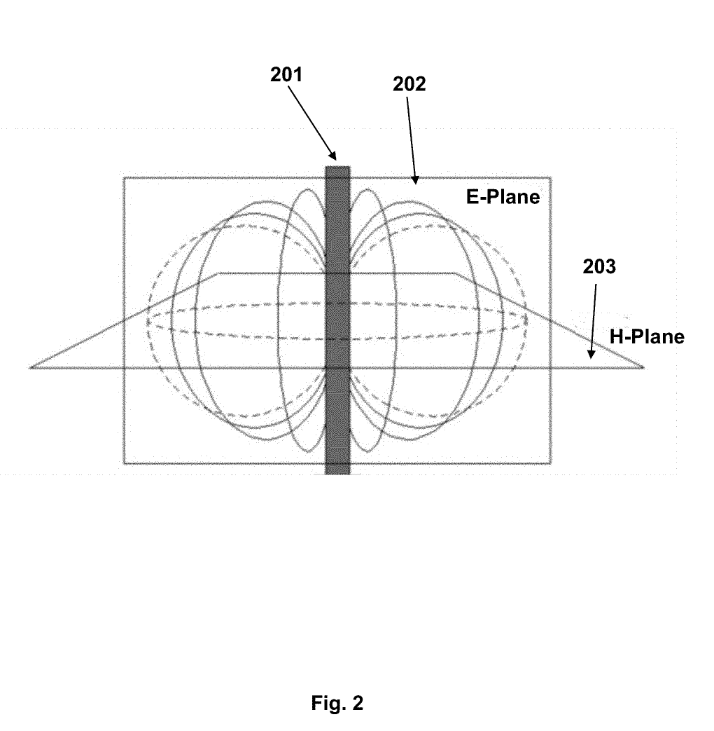

FIG. 2 illustrates a radiation pattern of a vertical antenna 201. The higher the gain (dBi) of the antenna, the flatter the sphere will be. The lowest gain is directly above and below the the vertically polarized antenna 201 unless deformed by other near field affects. Here, the E-Plane 202 is in the vertical position and the H-plane 203 is horizontal.

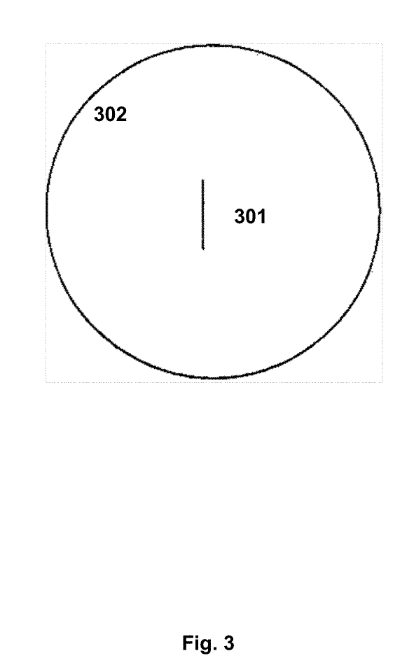

FIG. 3 illustrates a radiation pattern for a low dBi gain antenna such as a 2 dBi antenna as those used for cellular in order to get the best omni-direction performance. 302 is the pattern looking at the H-plane 203.

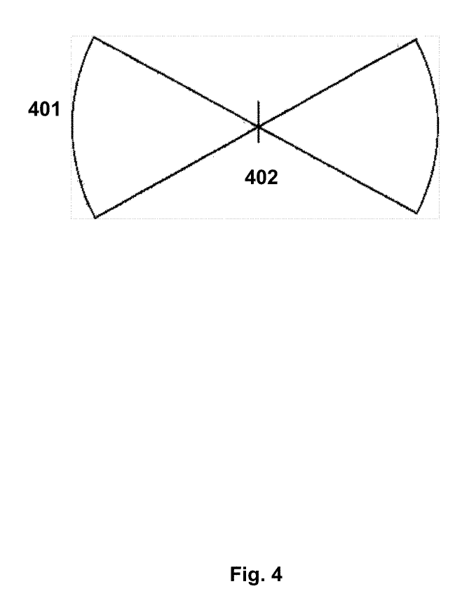

FIG. 4 illustrates a radiation pattern 401 for a vertically polarized antenna 402 with approximately 5 dBI gain. The pattern if looking at the H-Plane 203 is much narrower and more directional. This increases the effective useful distance of the transceiver. This is the type of antenna that would be typically used to improve indoor coverage of WiFi, Bluetooth, or other ISM band transceivers. It can be seen here that this type of antenna is in a portable, but stationary position (such as in a router, hub or other appliance) that the signal is strongest in the horizontal direction and not the vertical direction (not into the floor). Near field affects can substantially deform the pattern and reduce the efficiency of the antenna by detuning its performance.

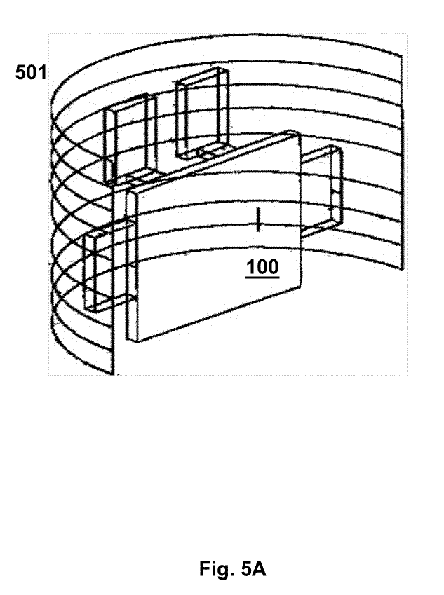

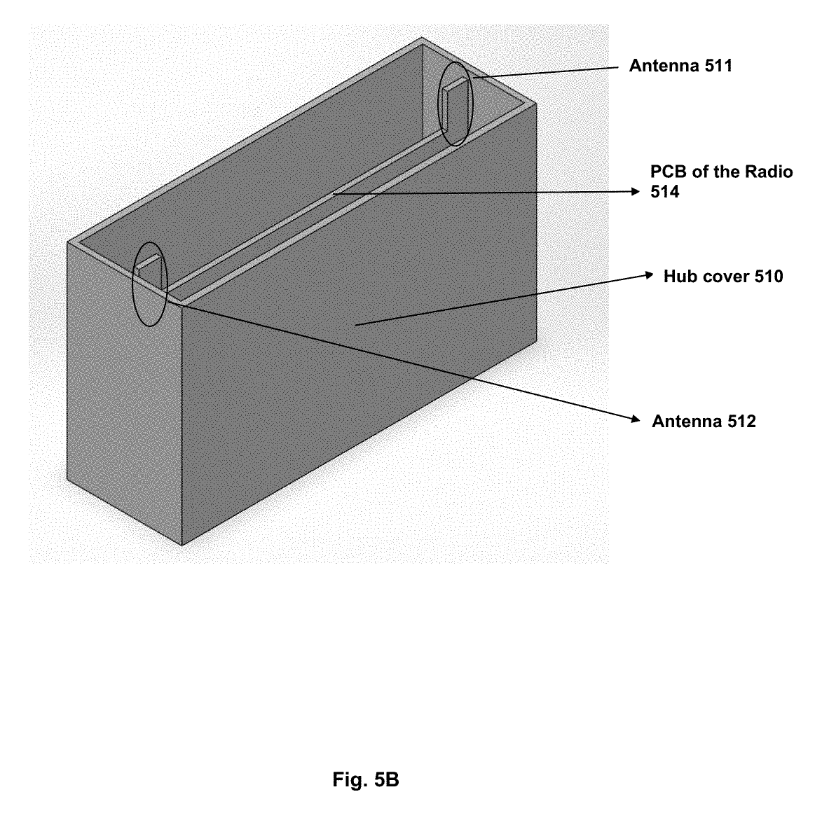

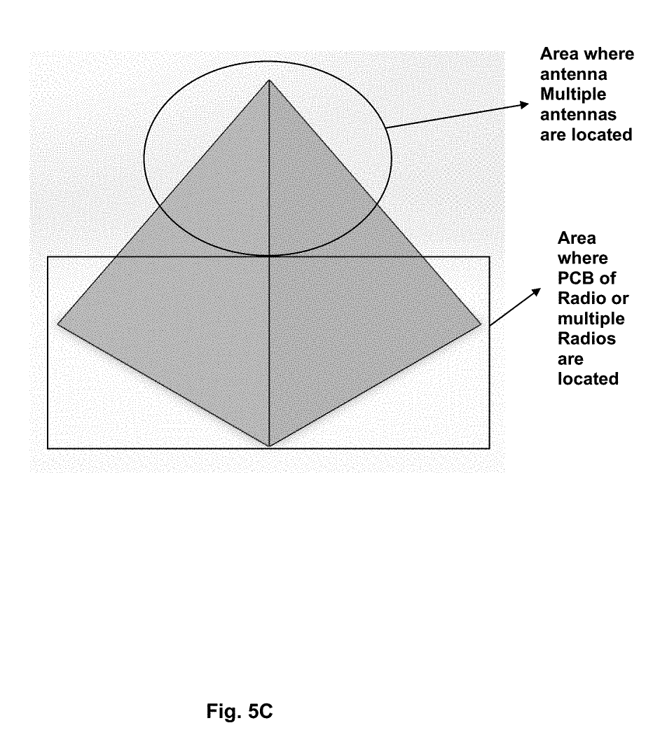

FIG. 5A illustrates the back side of an enclosure 501 for the device 100 according to an embodiment of the invention. Although a circular shaped back of the enclosure is shown, the enclosure may be rectangular or have angled sides as long as the enclosure provides sufficient distance between the antennas and the wall and the floor to minimize the near field effects on the antenna. Although only the back side of the enclosure 501 is shown, the enclosure is intended to fully enclose (not shown) the antennas.

FIG. 5B illustrates a rectangular enclosure (i.e., hub cover) 510 according to an embodiment of the invention. Here, antenna 511 and antenna 512 are completely enclosed by the hub cover 510 (top cover not shown). The antenna 511 and the antenna 512 implement different RF technologies including cellular technologies using licensed bands such as LTE with unlicensed bands (ISM) such as BLE. The hub cover 510 maintains a spatial relationship between the antennas 511 and 512 in order to minimize interference with each other. The shape of the enclosure 510 also fixes the distance from the walls, floor or ceiling of a building to reduce absorption and detuning of the enclosed antennas. The enclosure 510 has sufficient space to accommodate antennas 511 or 512 with circular or elliptical polarization for purposes of improving RF propagation. The antennas 511 and 512 are connected to the electronic circuit board 514, i.e., PCB via a connector or a connector and cable combination. Alternatively, the antennas 511 and 512 are fabricated on the electronic circuit board. The enclosure 510 is RF neutral.

FIG. 5C illustrates a pyramid shaped hub 520 according to an embodiment of the invention. The hub 520 is the same as hub 510 except for its shape. An antenna system such as those described above are housed at the tip portion of the pyramid 524. The electronic circuit board, e.g., 514, is housed at the bottom portion of the pyramid 524.

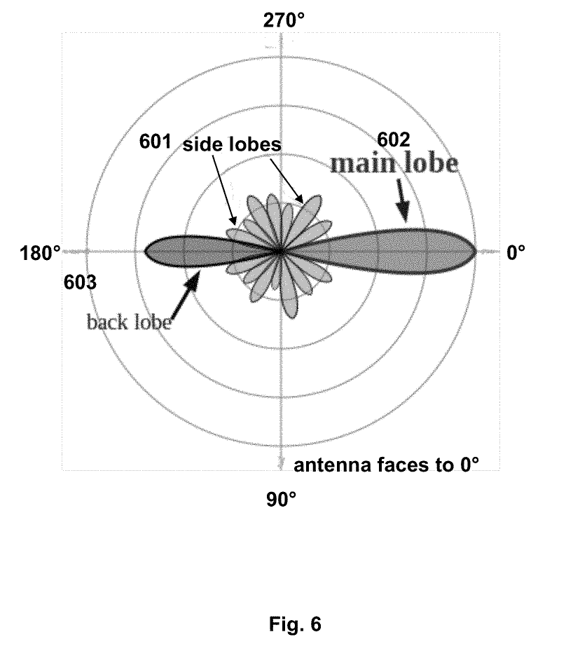

In all antennas, other than dipole and monopole, the radiation from the different parts of the antenna interfere with each other at some angles. This results in zero radiation at certain angles where the radio waves from the different parts arrive out of phase, and local maxima of radiation at other angles where the radio waves arrive in phase. Therefore, the radiation plot of most antennas shows a pattern of maxima called “lobes” at various angles, separated by “nulls” at which the radiation goes to zero. The larger the antenna is, compared to a wavelength, the more lobes there will be and the more directional the antenna will be. These are used when the objective is to direct the radio waves directionally and achieve higher dBi gain in that direction. FIG. 6 illustrates this directional behavior. The lobe in that direction is larger than the others; this is called the “main lobe” 602. The axis of maximum radiation, passing through the center of the main lobe, is called the “beam axis” or “boresight axis.” In some antennas, such as split-beam antennas, there may exist more than one major lobe. A minor lobe is any lobe except a major lobe. The other lobes, representing unwanted radiation in other directions, are called “side lobes” 601. The side lobe in the opposite direction (180°) from the main lobe is called the “back lobe” 603. Usually, it refers to a minor lobe that occupies the hemisphere in a direction opposite to that of the major (main) lobe.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

We claim:

1. A device comprising:
a first antenna associated with a first radio frequency (RF) technology;
a second antenna associated with a second RF technology, wherein the first RF technology and second RF technology are different; and
a pyramid shaped enclosure housing the first antenna and second antenna, and maintaining a spatial relationship between the first antenna and second antenna in order to minimize interference between the first antenna and second antenna.

2. The device of claim 1, wherein the first antenna or second antenna implements circular or elliptical polarization.

3. The device of claim 1, wherein the first RF technology is associated with a licensed band and the second RF technology is associated with an unlicensed band.

4. The device of claim 1, further comprising an electronic circuit board and the first antenna and second antenna are connected to the electronic circuit board through a connector, or a connector and cable.

5. The device of claim 1, further comprising an electronic circuit board, and the first antenna and second antenna are fabricated on the electronic circuit board.

6. A device comprising:
a first antenna associated with a first radio frequency (RF) technology;
a second antenna associated with a second RF technology, wherein the first RF technology and second RF technology are different; and
an RF neutral enclosure housing the first antenna and second antenna, and maintaining a spatial relationship between the first antenna and second antenna in order to minimize interference between the first antenna and second antenna.

7. The device of claim 6, wherein the first antenna or second antenna implements circular or elliptical polarization.

8. The device of claim 6, wherein the first RF technology is associated with a licensed band and the second RF technology is associated with an unlicensed band.

9. The device of claim 6, further comprising an electronic circuit board and the first antenna and second antenna are connected to the electronic circuit board through a connector, or a connector and cable.

10. The device of claim 6, further comprising an electronic circuit board, and the first antenna and second antenna are fabricated on the electronic circuit board.

11. A device comprising:
radio frequency (RF) circuitry;
an RF antenna coupled to the RF circuitry; and
an enclosure housing the RF antenna and RF antenna, and maintaining a spatial relationship between the RF circuitry and RF antenna in order to minimize interference between the RF circuitry and RF antenna.

12. The device of claim 11, wherein the RF circuitry and RF antenna implement one or more RF technologies.

13. The device of claim 11, wherein the enclosure is pyramid shaped.

14. The device of claim 11, wherein the enclosure is RF neutral.

15. The device of claim 11, wherein the RF antenna implements circular or elliptical polarization.

16. The device of claim 11, further comprising an electronic circuit board, the electronic circuit board including the RF circuitry, and the RF antenna is connected to the electronic circuit board through a connector, or a connector and cable.

17. The device of claim 11, further comprising an electronic circuit board, the electronic circuit board including the RF circuitry, and the RF antenna is fabricated on the electronic circuit board.
